(19) United States
(12) Patent Application Publication
(10) Pub. No.: US 2026/0123648 A1
(43) Pub. Date: May 7, 2026

(54) PEARL-MILK-TEA FLAVOR DAIFUKU STRUCTURE AND MANUFACTURING METHOD THEREOF

(71) Applicant: SAN SHU GONG FOOD CO., LTD., New Taipei City (TW)

(72) Inventor: Mei-Yao Chen, New Taipei City (TW)

(21) Appl. No.: 18/937,025

(22) Filed: Nov. 5, 2024

(51) Int. Cl. A23G 3/48; A23L 5/20; A23L 29/00; A23L 29/219; A23L 29/269; A23L 29/30

(52) U.S. Cl. CPC A23G 3/48; A23L 5/21; A23L 29/04; A23L 29/219; A23L 29/27; A23L 29/30

(57) ABSTRACT

Disclosed are a pearl-milk-tea flavor daifuku structure and a manufacturing method thereof. The daifuku includes, in order from the center outward, a first inner layer of pearl filling, a second inner layer of milk tea flavor filling, and a surface layer covering and enclosing the second inner layer and in a soft and dense form. The surface layer is present in an amount of 50% and is a mochi skin formed by subjecting maltose, granulated sugar, and acetylated distarch phosphate to stirring and steaming. The first inner layer is present in an amount of 16.7% and is formed by subjecting granulated sugar, hydroxypropyl distarch phosphate, and brown sugar to stirring and steaming. The second inner layer is present in an amount of 33.3% and is formed by subjecting sword jack bean, granulated sugar, and soybean oil to stirring and steaming.

### BACKGROUND OF THE INVENTION

### (a) Technical Field of the Invention

The present invention relates to a pearl-milk-tea flavor daifuku structure and a manufacturing method thereof, and more particularly to a pearl-milk-tea flavor daifuku structure that presents the taste of both mochi and pearl milk tea at the same time, making the daifuku present a unique and novel taste to increase the value of the daifuku product, and a manufacturing method thereof.

### (b) Description of the Prior Art

A general soft dessert of daifuku 1, as shown in FIG. 1, includes an outer layer 11 and a filling 12. The outer layer 1 is usually made of soft and thick rice material, and wrapped and enclosed in the outer layer 11 is a single filling 12 of different flavors, such as red beans, mung beans, chestnuts, and strawberries. This traditional soft dessert has maintained the flavor of existing and single filling 12 for a long time and does not have breakthrough development. As such, the consumers can only choose buying a preferred flavor of the traditional single-flavor daifuku, making it impossible to increase the product value of daifuku desserts.

In recent years, pearls (tapioca balls) are a very popular special food in Taiwan and are often made into pearl milk tea drinks or pearl ice products. They are not only widely loved by local people, but also popular abroad and favored by foreigners, because this kind of drink or ice product has both the sweet aroma of tea or ice product and the soft taste of pearls. However, this kind of compound taste has no use in other foods except pearl milk tea drink or ice product and this is quite a pity. In view of this, after continuous research and experiments, the applicant came up with the idea of creating a pearl-milk-tea flavor daifuku structure and a manufacturing method thereof, so that daifuku can form a composite taste, and can present the novelty of mochi and pearl milk tea at the same time when eating.

### SUMMARY OF THE INVENTION

The primary objective of the present invention is to provide a manufacturing method of a pearl pearl-milk-tea flavor daifuku structure, which uses pearl in combination with a sticky milk tea flavor filling and a mochi skin to provide a daifuku with a compound taste, presenting a novel taste of mochi and pearl milk tea when eating, thus increasing the product value of the daifuku.

For the aforementioned pearl-milk-tea flavor daifuku structure, the daifuku comprises, in order from center outward, a first inner layer of pearl filling, a second inner layer of milk tea flavor filling, and a surface layer covering and enclosing the second inner layer and in a soft and dense form. The surface layer is present in an amount of 50% and is a mochi skin formed and shaped by subjecting raw materials including maltose, granulated sugar, and acetylated distarch phosphate to stirring and steaming; the first inner layer is present in an amount of 16.7% and is pearl filling formed and shaped by subjecting raw materials including granulated sugar, hydroxypropyl distarch phosphate, and brown sugar to stirring and steaming; the second inner layer is present in an amount of 33.3% and is milk tea flavor filling formed and shaped by subjecting raw materials including sword jack bean, granulated sugar, and soybean oil to stirring and steaming; and the second inner layer and the first inner layer are covered by and enclosed in the surface layer through filling and shaping to form the pearl-milk-tea flavor daifuku. The daifuku presents a novel taste of mochi and pearl milk tea when eating, so that the product value of the daifuku is increased.

For the aforementioned pearl-milk-tea flavor daifuku structure, the raw materials of the surface layer comprise maltose of 44.00%, granulated sugar of 17.00%, acetylated distarch phosphate of 15.80%, hydroxypropyl distarch phosphate of 14.30%, water of 8.60%, spices of 0.17%, preservative (potassium sorbate) of 0.10%, fatty acid glyceride of 0.02%, and xanthan gum of 0.01%.

For the aforementioned pearl-milk-tea flavor daifuku structure, the raw materials of the first inner layer comprise maltose of 51.09%, granulated sugar of 20.47%, hydroxypropyl distarch phosphate of 14.25%, water of 8.60%, brown sugar of 5.34%, cocoa powder of 0.22%, fatty acid glyceride of 0.02%, and xanthan gum of 0.01%.

For the aforementioned pearl-milk-tea flavor daifuku structure, the raw materials of the second inner layer comprise sword jack bean of 60.80%, granulated sugar of 23.90%, soybean oil of 7.30%, maltose of 7.00%, and spices of 1.00%.

For a manufacturing method of the aforementioned the pearl-milk-tea flavor daifuku, the pearl filling and the milk tea flavor filling are filled in the mochi skin to be shaped into a daifuku semi-finished product, and the daifuku semi-finished product is subjected to flour coating, cutting, and shaping to form the pearl-milk-tea flavor daifuku.

For the aforementioned manufacturing method of pearl-milk-tea flavor daifuku, the steaming operations of the mochi skin raw material of the surface layer, the pearl filling raw material of the first inner layer, and the milk tea flavor filling raw material of the second inner layer are performed in such a way that the mochi skin raw material, the pearl raw material, and the milk tea flavor filling raw material that have been mixed and stirred are each steamed at a temperature of about 100° C. for about 20 minutes.

For the aforementioned manufacturing method of pearl-milk-tea flavor daifuku, the shaped daifuku semi-finished product is subjected to flour coating with 1% potato flour.

### BRIEF DESCRIPTION OF THE DRAWINGS

FIG. 1 shows a known daifuku in a sectioned form.

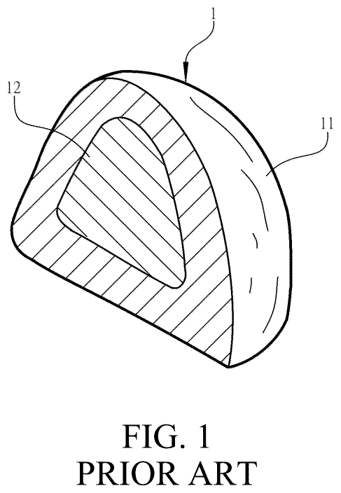

FIG. 2 shows a pearl-milk-tea flavor daifuku according to the present invention in a sectional form.

FIG. 3 is a flow chart showing manufacturing of a first inner layer of the present invention.

FIG. 4 is a flow chart showing manufacturing of a second inner layer of the present invention.

FIG. 5 is a flow chart showing manufacturing of a surface layer of the present invention.

FIG. 6 is a flow chart showing manufacturing of a pearl-milk-tea flavor daifuku according to the present invention.

FIG. 7 is a schematic view showing a forming apparatus according to the present invention.

### DETAILED DESCRIPTION OF THE PREFERRED EMBODIMENTS

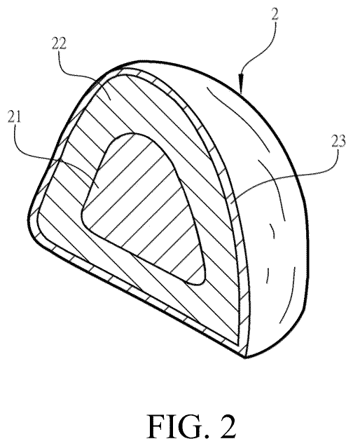

Referring to FIG. 2, which is a perspective view, partly sectioned, showing a pearl-milk-tea flavor daifuku according to the present invention, as shown in the drawing, the pearl-milk-tea flavor daifuku according to the present invention, generally designated at 2, comprises, in order from the center outward, a first inner layer 21, a second inner layer 22 covering and enclosing the first inner layer 21, and a surface layer 23 covering and enclosing the second inner layer 22. The first inner layer 21 comprises a pearl filling, and the second inner layer 22 comprises a sticky milk tea flavor filling. The surface layer 23 comprises a mochi skin that is generally in a soft and dense form. The second inner layer 22 covers and encloses the first inner layer 21 with an appropriate thickness, and the surface layer 23 covers and encloses the second inner layer 22 with an appropriate thickness. With the combination of the pearl filling of the first inner layer 21 with the milk tea flavor filling of the second inner layer 22, the pearl-milk-tea flavor daifuku 2 so produced forms a compound pearl milk tea flavor, making the pearl-milk-tea flavor daifuku 2 presenting a novel taste of mochi and pearl milk tea at the same time when eating.

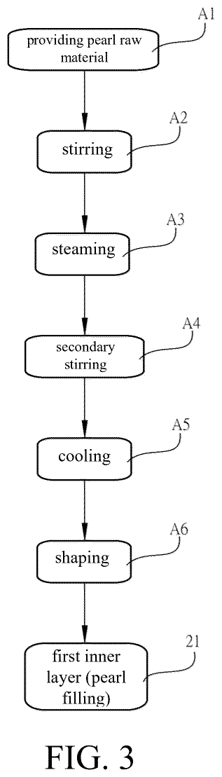

Referring to FIG. 3, which is a flow chart showing a manufacturing process of the first inner layer 21 according to the present invention, as shown in the drawing, the manufacturing process of the pearl filling of the first inner layer 21 according to the present invention comprises the following steps:
(1) providing pearl-filling raw material (Block A1), wherein the raw material comprises: maltose of 51.09%, granulated sugar of 20.47%, hydroxypropyl distarch phosphate of 14.25%, water of 8.60%, brown sugar of 5.34%, cocoa powder of 0.22%, fatty acid glyceride of 0.02%, and xanthan gum of 0.01%;
(2) stirring (Block A2), wherein a predetermined amount of the raw material provided in Step 1 is mixed and stirred;
(3) steaming (Block A3), wherein the raw material mixed and stirred in Step 2 is steamed at a temperature of about 100° C. for about 20 minutes;
(4) secondary stirring (Block A4), wherein the raw material steamed in Step 3 is stirred evenly;
(5) cooling (Block A5), wherein a semi-finished product obtained through stirring of Step 4 is placed at room temperature to cool; and
(6) shaping (Block A6), wherein a product cooled in Step 5 is used to form a pearl filling of the first inner layer 21.

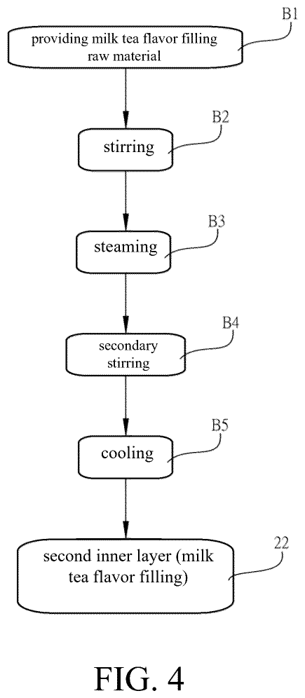

Referring to FIG. 4, which is a flow chart showing a manufacturing process of the second inner layer 22 according to the present invention, as shown in the drawing, the manufacturing process of the milk tea flavor filling of the second inner layer 22 according to the present invention comprises the following steps:
(1) providing milk-tea-flavor-filling raw material (Block B1), wherein the raw material comprises: sword jack bean of 60.80%, granulated sugar of 23.90%, soybean oil of 7.30%, maltose of 7.00%, and spices of 1.00%;
(2) stirring (Block B2), wherein a predetermined amount of the raw material provided in Step 1 is mixed and stirred;
(3) steaming (Block B3), wherein the raw material mixed and stirred in Step 2 is steamed at a temperature of about 100° C. for about 20 minutes;
(4) secondary stirring (Block B4), wherein the raw material steamed in Step 3 is stirred evenly; and
(5) cooling (Block B5), wherein a semi-finished product obtained through stirring, with sugar added, in Step 4 is placed at room temperature to cool so as to form a milk tea flavor filling of the second inner layer 22.

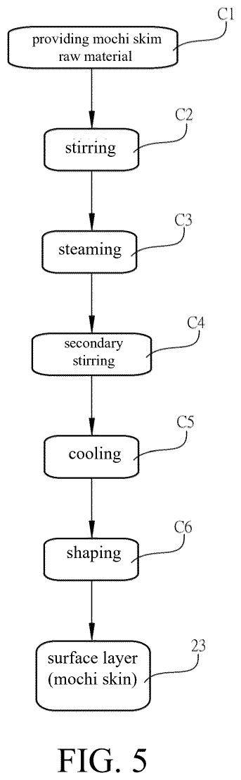

Referring to FIG. 5, which is a flow chart showing a manufacturing process of the surface layer 23 according to the present invention, as shown in the drawing, the manufacturing process of the mochi skin of the surface layer 23 according to the present invention comprises the following steps:
(1) providing mochi skin raw material (Block C1), wherein the raw material comprises: maltose of 44.00%, granulated sugar of 17.00%, acetylated distarch phosphate of 15.80%, hydroxypropyl distarch phosphate of 14.30%, water of 8.60%, spices of 0.17%, preservative (potassium sorbate) of 0.10%, fatty acid glyceride of 0.02%, and xanthan gum of 0.01%;
(2) stirring (Block C2), wherein a predetermined amount of the raw material provided in Step 1 is mixed and stirred;
(3) steaming (Block C3), wherein the raw material mixed and stirred in Step 2 is steamed at a temperature of about 100° C. for about 20 minutes;
(4) secondary stirring (Block C4), wherein the raw material steamed in Step 3 is stirred evenly;
(5) cooling (Block C5), wherein a mochi-skin semi-finished product obtained through stirring, with sugar added, in Step 4 is placed at room temperature to cool; and
(6) shaping (Block C6), wherein the cooled semi-finished product is used to form a mochi skin of the surface layer 23.

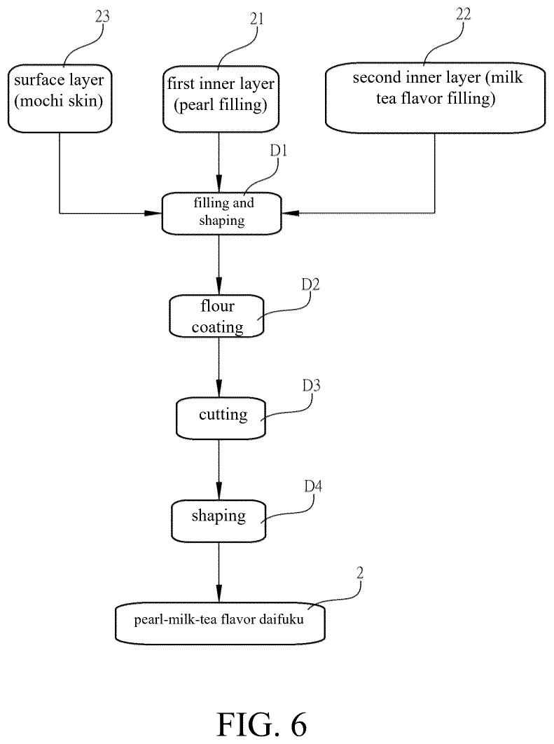

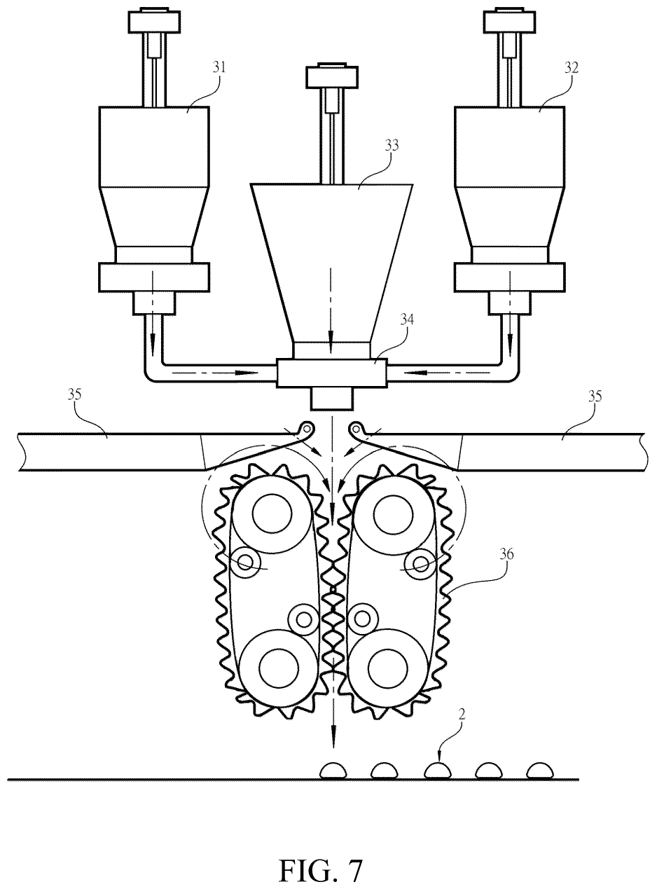

Referring to both FIGS. 6 and 7, which are respectively a flow chart showing a manufacturing method of the pearl-milk-tea flavor daifuku 2 according to the present invention and a forming apparatus thereof, as shown in the drawings, the manufacturing method of the pearl-milk-tea flavor daifuku 2 according to the present invention comprises the following steps:
(1) filling and shaping (Block D1), wherein the pearl filling of the first inner layer 21 and the milk tea flavor filling of the second inner layer 22 are filled into the mochi skin of the surface layer 23, wherein in the instant embodiment, a forming apparatus 3 is provided with a first storage container 31 in which pearls are received and held, a second storage container 32 in which the milk tea flavor filling is received and held, and a third storage container 33 in which the mochi skin is received and held, wherein the first storage container 31, the second storage container 32, and the third storage container 33 are each connected by a conveying pipe to a filling and shaping unit 34, and the filling and shaping unit 34 fills the pearls and the milk tea flavor filling into the mochi skin to be extruded into a round long strip that hangs down from the filling and shaping unit 34;
(2) Flour coating (Block D2), wherein a semi-finished product filled and shaped in Step 1 is coated with 1% potato flour, wherein in the instant embodiment, flour spraying units 35 are respectively provided on two sides below the filling and shaping unit 34 to spray the potato flour on the filled and shaped semi-finished product that is in the form of an elongated strip;
(3) cutting (Block D3), in which the semi-finished product of step 2 is cut into a daifuku semi-finished product of an appropriate size, wherein in the instant embodiment, a cutting unit 36, which is of a symmetric arrangement, is provided below the filling and shaping unit 34, so that the semi-finished product of step 2 in the form of an elongated strip is cut into a daifuku semi-finished product of an appropriate size by means of rubbing in a horizontal direction and rotation in opposite directions performed with the cutting unit 36;
(4) Shaping (Block D4), wherein the daifuku semi-finished product of step 3 is shaped, wherein in the instant embodiment, the daifuku semi-finished product formed through cutting in step 3 is rubbed in a horizontal direction at a lower side of the cutting unit 36 to have the daifuku semi-finished product shaped; and
(5) a final product of pearl-milk-tea flavor daifuku 2 in a granular form is formed through shaping in step 4.

The foregoing embodiments are only for illustrating the preferred ways of implementation of the present invention, rather than limiting the scope of the present invention. Minor modifications and variations will still not lose the essence of the present invention, nor will it deviate from the spirit of the present invention.

In summary, the present invention provides a manufacturing method in which a first inner layer of pearl filling is used in combination with a second inner layer of milk tea flavor filling, together with a surface layer made of a mochi skin, to form a pearl-milk-tea flavor daifuku structure. By combining pearls with sticky milk tea flavor filling, the daifuku can be formed with a compound taste, presenting a novel taste of mochi and pearl milk tea when eating, thus increasing the product value of daifuku.

I claim:

1. A pearl-milk-tea flavor daifuku structure, comprising, in order from center outward, a first inner layer, a second inner layer covering and enclosing the first inner layer, and a surface layer covering and enclosing the second inner layer, wherein the surface layer comprises a mochi skin, which is present in an amount of 50%; the first inner layer comprises a pearl filling, which is present in an amount of 16.7%; and the second inner layer comprises a milk tea flavor filling, which is present in an amount of 33.3%; and wherein the second inner layer and the first inner layer are covered by and enclosed in the surface layer through filling and shaping to form the pearl-milk-tea flavor daifuku.

2. The pearl-milk-tea flavor daifuku structure according to claim 1, wherein the surface layer comprises maltose of 44.00%, granulated sugar of 17.00%, acetylated distarch phosphate of 15.80%, hydroxypropyl distarch phosphate of 14.30%, water of 8.60%, spices of 0.17%, preservative (potassium sorbate) of 0.10%, fatty acid glyceride of 0.02%, and xanthan gum of 0.01%.

3. The pearl-milk-tea flavor daifuku structure according to claim 1, wherein the first inner layer comprises maltose of 51.09%, granulated sugar of 20.47%, hydroxypropyl distarch phosphate of 14.25%, water of 8.60%, brown sugar of 5.34%, cocoa powder of 0.22%, fatty acid glyceride of 0.02%, and xanthan gum of 0.01%.

4. The pearl-milk-tea flavor daifuku structure according to claim 1, wherein the second inner layer comprises sword jack bean of 60.80%, granulated sugar of 23.90%, soybean oil of 7.30%, maltose of 7.00%, and spices of 1.00%.

5. A method for manufacturing pearl-milk-tea flavor daifuku, comprising the following steps:
providing a predetermined amount of pearl filling raw material to be mixed and stirred, and steamed;
subjecting the steamed pearl filling raw material to secondary stirring in an even form and placing a stirred semi-finished product at room temperature for cooling to form pearl filling;
providing a predetermined amount of milk tea flavor filling raw material to be mixed and stirred, and steamed;
subjecting the steamed milk tea flavor filling raw material to secondary stirring in an even form, and placing a stirred semi-finished product at room temperature for cooling to form milk tea flavor filling;
providing a predetermined amount of mochi skin raw material to be mixed and stirred, and steamed;
subjecting the steamed mochi skin raw material to secondary stirring in an even form, and placing a semi-finished product obtained through stirring with sugar added at room temperature for cooling;
shaping the cooled semi-finished product into a mochi skin; and
filling the pearl filling and the milk tea flavor filling into the mochi skin to be shaped into a daifuku product, and subjecting the daifuku product to flour coating, cutting, and shaping to form a pearl-milk-tea flavor daifuku.

6. The method for manufacturing pearl-milk-tea flavor daifuku according to claim 5, wherein the pearl filling, the milk tea flavor filling, and the mochi skin are steamed at a temperature of 100° C. for 20 minutes.

7. The method for manufacturing pearl-milk-tea flavor daifuku according to claim 5, wherein the flour coating of the shaped daifuku product is performed with 1% potato flour.
